(19) United States
(12) Patent Application Publication
(10) Pub. No.: US 2004/0153636 A1
(43) Pub. Date: Aug. 5, 2004

(54) RISC type of CPU and compiler to produce object program executed by the same

(76) Inventors: Masahiro Kamiya, Nishio-shi (JP); Yoshinori Teshima, Toyota-shi (JP); Hideaki Ishihara, Okazaki-shi (JP)

Correspondence Address: HARNESS, DICKEY & PIERCE, P.L.C., P.O. BOX 828, BLOOMFIELD HILLS, MI, 48303, US

(21) Appl. No.: 10/744,650

(22) Filed: Dec. 23, 2003

(30) Foreign Application Priority Data
Dec. 25, 2002 (JP) 2002-374527

(51) Int. Cl. G06F 15/00

(52) U.S. Cl. 712/244

(57) ABSTRACT

A RISC type of CPU is provided to execute an object program in which a stack area is used. The CPU is configured to have a return instruction based on an operand at which an open size is specified and to perform the return instruction when the stack area is required to be opened in returning processing executed by the CPU from interrupt processing to ordinary processing with no interrupt. Also a compiler is provided to compile a source program into the object program. The compiler determines whether or not a stack area in the source program is required to be opened when processing in the source program is returned from interrupt processing to ordinary processing with no interrupt and produces codes of the object program in which an operand for a return instruction is included and an open size for the stack area is specified at the operand.

### BACKGROUND OF THE INVENTION

1. Technical Field

The present invention relates to a RICS (Reduced Instruction Set Computer) type of CPU (Central Processing Unit), a compiler to produce an object program executed by the CPU, a microcomputer equipped with both the CPU and a co-processor working as an auxiliary processor, and a processor installed in the microcomputer.

2. Related Art

In general, programs for computers are developed such that source programs are first described using high-level languages such as C++ and then compiled by a compiler into object programs written on a CPU-executable format.

During executing a program, a CPU should carry out interrupt processing whenever an interrupt is commanded. FIG. 1A explains a sequence for interruptive processing, while FIG. 1B exemplifies a series of object codes for an interruptive processing program in a mnemonic form.

Precisely, in this interruptive processing, a stack area to be used is first secured (Step A1), and data of a register and a return address is stored temporarily into the secured stack area (step A2). Processing according to the type of an interrupt is then executed (step A3). The data that has been stored in the stack area is returned to the register (step A4), before the stack area secured at step A1 is opened (step A5 [add.b #36, sp]. After this, the return address is set to a program counter, which allows the currently executed interruptive processing to return to the ordinary (i.e., non-interruptive) processing (step A6, [rt13]).

There are various RISC type CPUs each capable of issuing a program branch instruction as an instruction with delayed processing (delay branch instruction). That is, in pipeline processing inherent to the RISC type of CPU, a branch instruction is executed, there arises a vacancy in the pipeline processing, reducing efficiency of the processing. The delay branch instruction assigns the processing of another instruction to the “vacancy” in the pipeline processing, so that other instructions can be executed in parallel to the execution of the branch instruction (as explained in FIG. 2A).

The RISC type of CPU uses a less number of instructions to improve the pipeline processing. Hence, performing computation such as multiplication, division, and residue calculation, may require that a co-processor serving as an auxiliary processor be used for the computation. If such a co-processor is used, the co-processor is frequently connected to the CPU via a dedicated bus. This results in an increased amount of wiring. As known from Japanese Patent Laid-open publication No. 10-289120, one countermeasure to suppress such an increase in the wiring amount is to connect both the co-processor and the CPU through a versatile bus connected in common with a peripheral circuit including a ROM and a RAM.

(1) In this way, the interrupt processing is carried out to literally interrupt during the ordinary processing, and it is desired that the processing for the interrupt be as shorter in time as possible and be returned to the ordinary processing. However, the processing at the steps A1, A2, and A4 to A6 should be done at any time, being impossible to omit the processing at those steps. This means that it is difficult to shorten the processing time any more.

The CPU-handled interrupt is generally classified into two types: one is an exceptional interrupt responsive to any error, while the other is an ordinary interrupt other than the exceptional interrupt. As compared to the ordinary interrupt, the exceptional interrupt is higher in the priority, so that even when an ordinary interrupt may occur during the execution of the exceptional interrupt, the CPU is masked. Therefore, the conventional user program should be programmed such that both types of interrupt processing are distinguished from each other in performing their tasks.

(2) However, as to the kinds of instructions (for example, branch instruction) and processing procedures in the program, there is a limitation in the number of instructions executable in parallel to the branch instruction. When the delay branch instruction is compiled in the compile processing by the compiler, an instruction executed in parallel to the delay branch instruction should always be outputted. If there is no such an instruction executable in parallel, a “nop (No Operation)” instruction, which is an instruction for performing nothing, will be outputted, as shown in FIG. 2B. Accordingly, an object program includes the code of the nop instruction, which is basically unnecessary, resulting in an increased capacity of a program memory the object program.

(3) In cases where both the CPU and the co-processor are mutually connected by a general bus, unintended accesses may occur due to bugs or other defects in the program. Such an unintentional access would prevent a debugging operation from being performed in a smooth and steady manner.

In addition, to cope with an interrupt occurring during the operation of the CPU that allows the co-processor to performing its computation, the CPU should be provided with a mechanism for some countermeasure. Such a countermeasure should be responsible for (1) discarding the currently performed commutation en route to re-perform the computation from its position at which the interrupt occurred, (2) holding the state in the course of the computation, or (3) prohibiting the interrupt during the computation.

Of these countermeasures, the simplest one is prohibiting the interrupt during the computation. However, this countermeasure still faces the following difficulties. For example, a software program (user program) may be produced to allow execute an interrupt prohibiting instruction before making the co-processor start its calculation and then execute an interrupt permitting instruction after the calculation at the co-processor. In this case, the number of instructions increases due to the performance of both the interrupt prohibiting and permitting instructions, which results in an increase in the capacity of a program memory.

A situation is also considered, in which the co-processor outputs an interrupt prohibiting instruction in order to prohibit the CPU from interrupting during a period of time from the start of calculation to the end thereof. To employ this configuration is however to increase the number of dedicated signal lines by one. In addition to this drawback, there is a problem that the performance for real-time processing decreases, due to the fact that interrupt processing cannot be executed when the CPU is brought into an interrupt-prohibited state thereof.

### SUMMARY OF THE INVENTION

The present invention has been made with due consideration to the foregoing difficulties, and a first object of the present invention is to provide a RISC type of CPU and a complier, in which the number of cycle instructions for the return from interrupt processing can be reduced.

A second object of the present invention is to provide not only a RISC type of CPU that requires no output of unnecessary instructions into an object program but also a complier that does not output unnecessary instructions into an object program.

Still, a third object of the present invention is to provide a RISC type of CPU and a compiler, which maintain those configurations as simple as possible and capable of prohibiting an interrupt, in cases where a co-processor is used to make it calculate, a microcomputer equipped with both the CPU and the compiler, and the co-processor installed in the microcomputer.

In order to realize the first object, a first aspect of the present invention is provided by a RISC type of CPU executing an object program in which a stack area is used. The CPU comprises means configured to have a return instruction based on an operand at which an open size is specified; and means configured to perform the return instruction when the stack area is required to be opened in returning processing executed by the CPU from interrupt processing to ordinary processing with no interrupt.

Also, the first object is realized by another aspect of the present invention, which is a compiler for compiling a source program into object codes. The compiler comprises means configured to determine whether or not a stack area in the source program is required to be opened when processing in the source program is returned from interrupt processing to ordinary processing with no interrupt; and means configured to produce the object codes in which an operand for a return instruction is included and an open size for the stack area is specified at the operand.

Further, in order to realize the second object, another aspect of the present invention is provided by a RISC type of CPU executing an object program in which instructions are written. The CPU comprises means configured to read a branch instruction in the object program, the branch instruction having a delay branch option for determining whether or not an instruction described next to the branch instruction is required to be executed; and means configured to decide whether or not the object program is branched depending on the delay branch option.

Also, the second object is realized by another aspect of the present invention, which is a compiler for compiling a source program into object codes. The compiler comprises; means configured to determine whether or not an instruction described before a branch instruction having a delay slot in the source program is executable at the delay slot of the branch instruction; means configured to set to the branch instruction a delay branch option indicative of “delay processing is required,” when the instruction described before the branch instruction is executable and to arrange the executable instruction next to the branch instruction; and means configured to produce the object codes in which a further delay branch option indicative of “delay processing is not required,” when the instruction described before the branch instruction is not executable is set to the branch instruction.

Further, in order to realize the third object, another aspect of the present invention is provided by a RISC type of CPU executing an object program in which instructions are written. The CPU comprises means configured to have a dedicated instruction decodable by only a co-processor, the dedicated instruction being one of the instructions in the object program and being used to have access to the co-processor; and means configured to prohibit an interrupt from being received during a period of time in which the dedicated instruction is decoded or executed.

Also a compiler is provided for compiling a source program into object codes executed by a RISC type of CPU, instructions being written in the object codes. The CPU comprises means configured to output a dedicated instruction decodable by only a co-processor, the dedicated instruction being one of the instructions in the object codes and being used to have access to the co-processor; and means configured to prohibit an interrupt from being received during a period of time in which the dedicated instruction is decoded or executed, the compiler comprising; means configured to determine information set by a user, the information indicative of which of the co-processor and a library is to perform calculation necessary for executing the object codes; and means configured to selectively specify, every file of the source program, either one of the co-processor and the library to perform the calculation depending on the determined information.

Still, to realize the third object, as another aspect of the present invention, a microcomputer is provided. The microcomputer comprises a RISC type of CPU executing an object program in which instructions are written. The CPU comprises means configured to output a dedicated instruction decodable by only a co-processor, the dedicated instruction being one of the instructions in the object program and being used to have access to the co-processor, and means configured to prohibit an interrupt from being received during a period of time in which the dedicated instruction is decoded or executed; and a co-processor connected to the CPU via a bus.

To realize the third object, another aspect of the present invention is provided as a co-processor connected to a RISC type of CPU to form a microcomputer. The CPU executes an object program in which instructions are written. In this configuration, the CPU comprises means configured to output a dedicated instruction decodable by only a co-processor, the dedicated instruction being one of the instructions in the object program and being used to have access to the co-processor, and means configured to prohibit an interrupt from being received during a period of time in which the dedicated instruction is decoded or executed.

### BRIEF DESCRIPTION OF THE DRAWINGS

Other objects and aspects of the present invention will become apparent from the following description and embodiments with reference to the accompanying drawings in which:

FIG. 1A is a flowchart for ordinary interrupt processing in a program complied by a conventional complier;

FIG. 1B illustrates the conventionally compiled program in mnemonic codes;

FIGS. 2A to 2B exemplify processed results by the flowchart show by FIG. 1A;

FIG. 3 shows the configuration of a program conversion apparatus according to various embodiments of the present invention;

FIG. 4 conceptually shows compile processing executed by a compiler employed by a first embodiment of the present invention;

FIG. 5 is a functional block diagram showing the electrical configuration of a one-chip microcomputer adopted by the compiler;

FIG. 6 is a flowchart showing only a necessary part of compile processing executed by the compiler, the compile processing being according to the first embodiment;

FIG. 7A is a flowchart for ordinary interrupt processing in a program complied by the complier;

FIG. 7B illustrates the program in mnemonic codes;

FIG. 8 illustrates the bit configuration of an interrupt return instruction;

FIG. 9 shows pipeline processing when a CPU executes an interrupt return instruction;

FIG. 10 shows pipeline processing when a return instruction is executed based on an object program compiled in the conventional manner;

FIG. 11 is a flowchart showing only a necessary part of compile processing executed by a compiler, the compile processing being according to a second embodiment of the present invention;

FIG. 12A shows a source code program for an exceptional interrupt;

FIG. 12B shows an object code program from the source code program shown in FIG. 12A;

FIG. 13A shows a source code program for an ordinary interrupt;

FIG. 13B shows an object code program from the source code program shown in FIG. 13A;

FIG. 14 shows the bit configuration of a system register serving as an internal register of the CPU;

FIGS. 15A to 15C exemplify bit configurations of three types of delay branch instructions produced by a compiler according to a third embodiment of the present invention;

FIG. 16 is a flowchart showing only a necessary part of compile processing executed by the compiler, the compile processing being according to the third embodiment;

FIGS. 17A to 17C exemplify processed results by the flowchart shown by FIG. 16;

FIGS. 18A to 18E show pipeline-processed states executed by the CPU, in cases where delay options “0 to 2” are set concerning each branch instruction;

FIG. 19 is a functional block diagram showing the internal configuration of a co-processor employed in a fourth embodiment of the present invention;

FIG. 20 shows a correspondence between the types of calculation executed by the co-processor and setting of registers according to the calculation types;

FIG. 21 shows the bit configuration of a transfer instruction toward the co-processor owned by the CPU;

FIG. 22 is a functional block diagram outlining the internal configuration of the CPU;

FIG. 23 is a flowchart showing only necessary part of decode processing executed by a decoder in a controller of the CPU, the decode processing being corresponding to a fourth embodiment of the present invention;

FIG. 24 exemplifies an object code produced by a compiler when the CPU uses a co-processor to calculate;

FIG. 25 explains pipeline processing and output states of respective signals, which are realized during an execution of the object code shown in FIG. 24 is executed;

FIG. 26 is a functional block diagram showing the electrical configuration of a one-chip microcomputer in a fifth embodiment according to the present invention;

FIG. 27 is a flowchart showing only necessary part of processing executed by a compiler according to a fifth embodiment of the present invention; and

FIG. 28 shows an object code produced by the processing shown in FIG. 27.

### DETAILED DESCRIPTION OF PREFERRED EMBODIMENTS

Referring to the accompanying drawings, preferred embodiments of the present invention will now be described.

(First Embodiment)

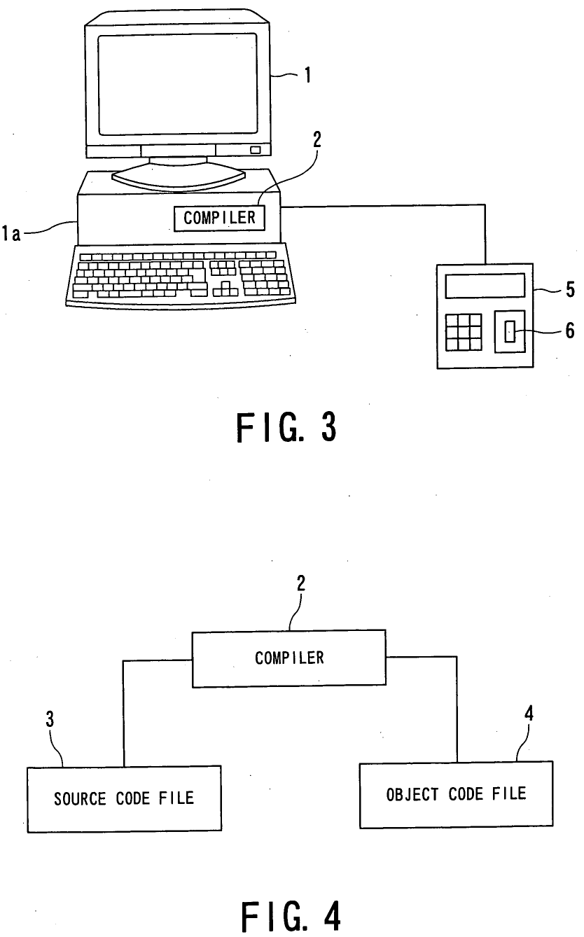

Referring to FIGS. 3 to 10, a first embodiment of the present invention will now be described.

First, with reference to FIG. 3, a program conversion apparatus will now be explained. The program conversion apparatus shown in FIG. 3 is composed of a personal computer (or workstation) 1, in which a compiler is installed. Specifically, a program file for the compiler 2 is stored in a storage (memory means), such as hard disk, incorporated in a main unit 1a of the personal computer 1.

In the storage of the main unit, a source code file 3 is also stored. The source code file 3 is rewritten by a user with a high-level language, such as C language. When the user starts up the program of the compiler 2 in the personal computer 1, the source code file 3 is converted and produced into an object code file 4. Specifically, as pictorially shown in FIG. 4, the compiler 2 reads out source codes described with the C language in the source code file 3, and decode them. The compiler 2 thus compiles the decoded source codes to produce object codes, which allow a CPU or other processors to perform processing corresponding to the object codes in the highest efficiency with the use of instructions inherent to the object codes.

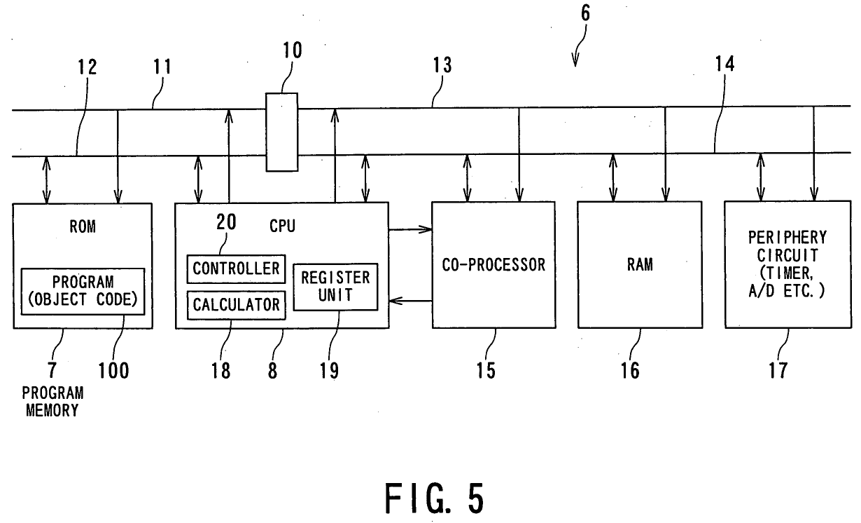

A ROM writer 5 is connected to the main unit 1a of the personal computer 1 in such a manner that both the ROM writer and the main unit can be communicated to each other based on a serial communication protocol, such as RS-232C. When transferred to the ROM writer 5, the object code file 4, which has been produced by the complier 2, is written into a ROM 7 (i.e., a program memory shown in FIG. 5) incorporated in the one-chip type of microcomputer 6 set in the ROM writher 5 as a program 100 written in binary data.

FIG. 5 shows a functional block diagram focusing on the electrical configuration of the one-chip microcomputer 6. The microcomputer 6 is configured with the use of a RISC type of CPU 8, which serves as one main component. The CPU 8 is connected with the ROM 7 via a bus connecting device 10 and a bus configuration consisting of a first address bus 11 and a first data bus 12. The ROM 7 is composed of a memory device, such as EEPROM or flash ROM. Both a second address bus 13 and a second data bus 14 are still branched from the bus connecting device 10, those two types of buses 13 and 14 being connected with a co-processor 15, a RAM 16, and a periphery circuit 17 including a timer and an A/D converter.

In the CPU8, various types of components are arranged, which include calculator 18 called ALU (Arithmetic Logical Unit) for calculation, a register unit 19, and a controller 20. The register unit 19 is made up of plural registers for use of calculation performed by the calculator 18. The controller 20 is placed to control the loading, storing and other operations of the register unit 19 and others.

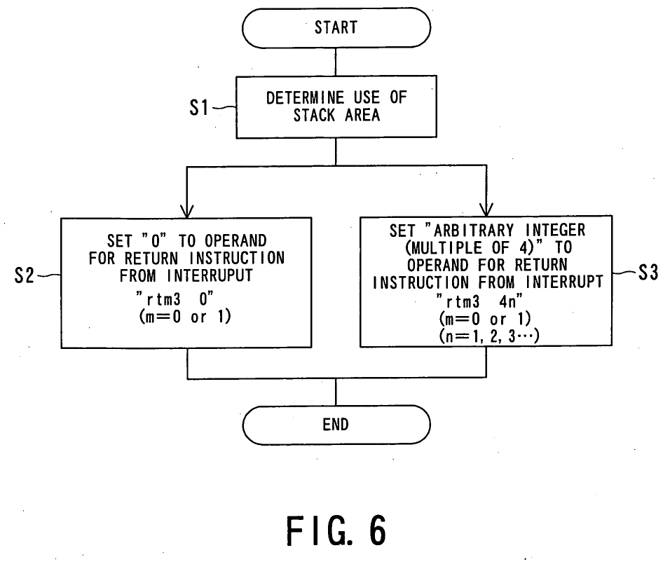

FIG. 6 shows, as to only part relating to the present embodiment, compile processing performed by the compiler 2. The source code file 3 includes interrupt processing, with which the compiler 2 operates as follows. The compiler 2 determines whether or not a stack area is used (step S1). If the determination shows that the stack area is used (YES), a specified value corresponding to a stack open size is set to an operand part of a return instruction [rtm3], the specified value being a multiple of 4 (step S3).

By contrast, the determination at step S1 shows NO, that is, the stack area is not used by the interrupt processing, a value “0” is set to the operand part of the return instruction [rtm3] (step S2).

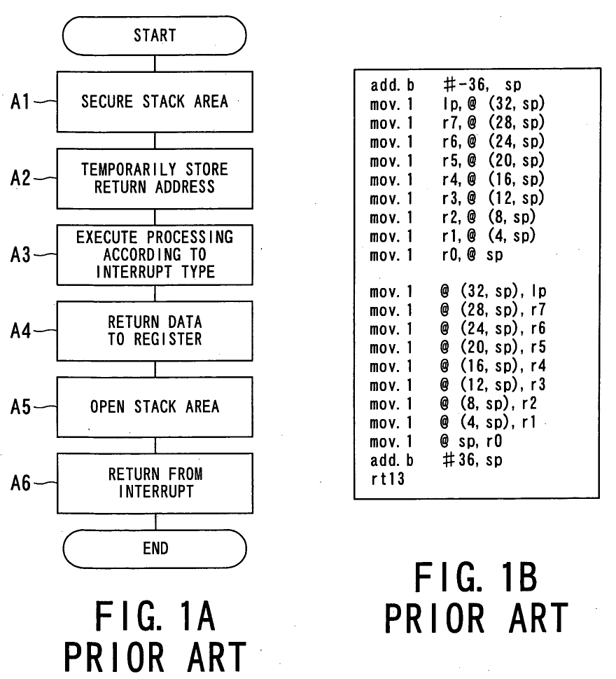

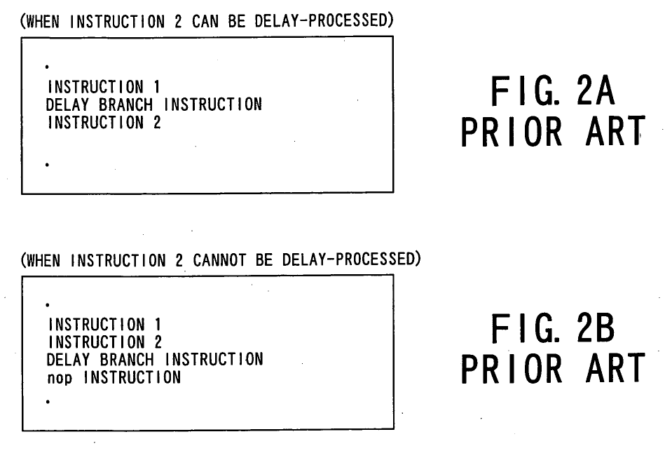

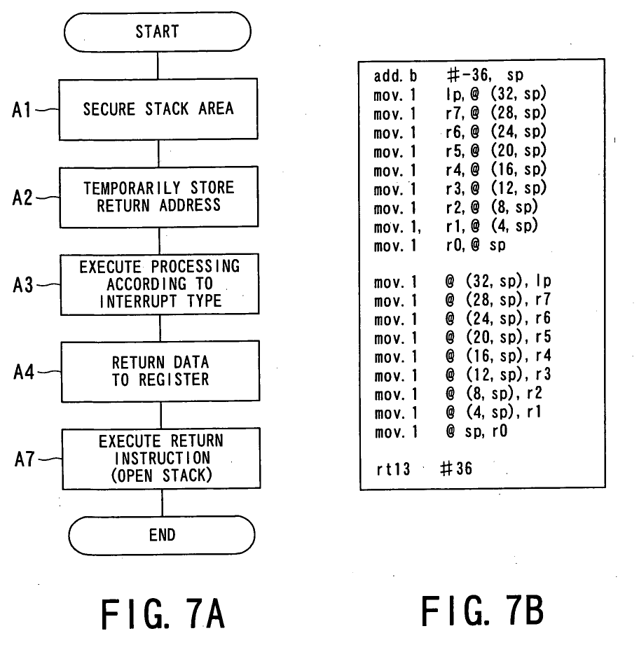

FIG. 7A shows a flowchart of an ordinary interrupt in a program 100 complied by the compiler 2, while the FIG. 7B shows the program expressed in mnemonic codes. For making an understanding easier, it is better to compare FIGS. 7A and 7B to FIGS. 1A and 1B. As can be seen from FIG. 7A, the process at step A5 in FIG. 1A is omitted and the process at step A6 in FIG. 1A is replaced by step A7 instructing “a return from the interrupt (open the stack).”

An instruction for the process at step A7 in FIG. 7B is given by a formula of

rt 13 #36 (1)

(m=1). In other words, in the case of the conventional way, an instruction of

step A5: add. B #36,sp (2)

makes the stack area open and an instruction of

step A6: rt13 (3)

enables a return from an interrupt (and an open of the stack in response to a returned address). In the present embodiment, the conventional way is substituted with the configuration where coding is made such that the foregoing one-line instruction shown in the formula (1) executes both the open and the return simultaneously.

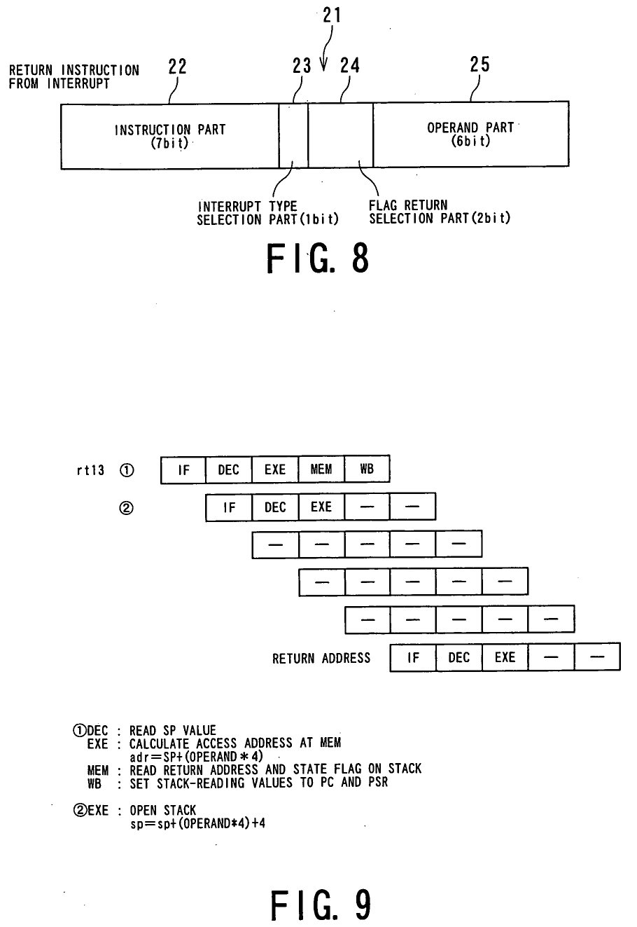

FIG. 8 shows the bit configuration of a return instruction 21 expressed by the formula (1). The return instruction [rtm3] is composed of a 7-bit instruction part 22, 1-bit interrupt type selection part (m) 23, 2-bit flag return selection part 24, and 6-bit operand part 25. Though the operand for the return instruction expressed by the formula (1) is [#36], its corresponding machine language is different from that; [9] resulting from the division of a value 36 is divided by 4 is loaded into the operand part 25.

The CPU 8 executes the return instruction in the formula (1) (i.e., at step A7) through pipeline processing shown in FIG. 9. This pipeline processing consists of five stages, each of which is configured as follows.

IF: instruction fetch

DEC: decode

EXE: instruction execution

MEM: memory (external device) access

WB: write back (register writing)

In a pipeline (1), a value of a stack pointer SP is read in at DEC of [rt13], and then an access address “adr” at the MEM next to the EXE is computed at the EXE using the following formula:

adr=sp+(operand×4) (4).

At the succeeding MEM, both of a return address on the stack and a state flag thereof are read. The processing is then moved to the WB, at which the return address is set to a program counter PC and the state flag is set to a status register PSR, respectively. At the EXE in a pipeline (2), the stack area is opened in block. In other words, the stack pointer SP is set based on the following formula (5):

sp=sp+(operand×4)÷4 (5).

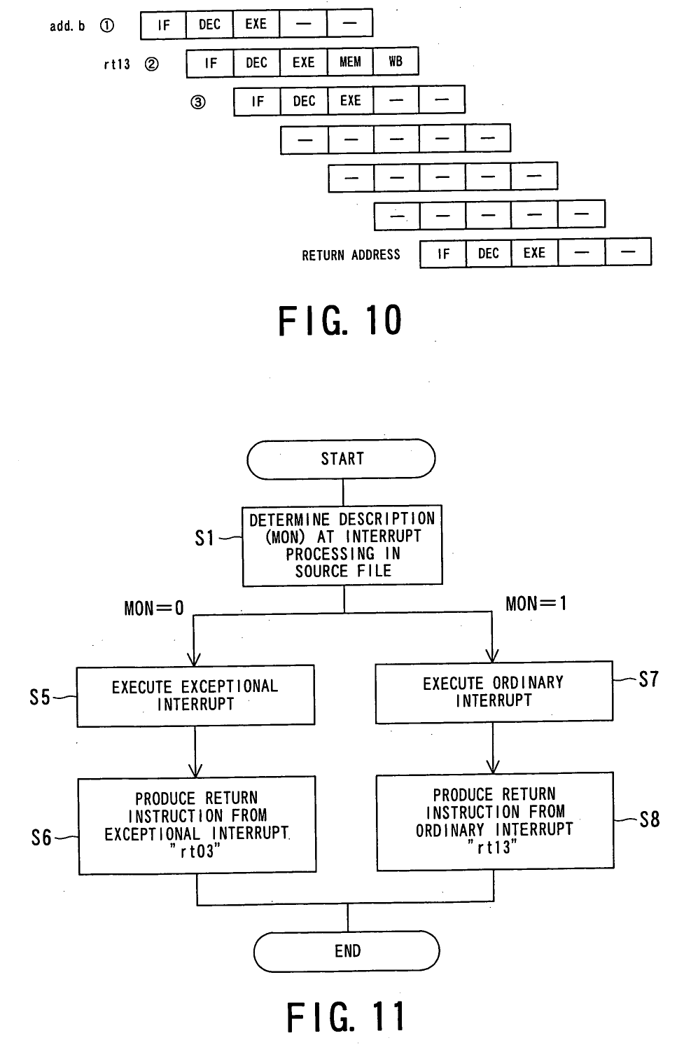

To make the comparison with the conventional easier, FIG. 10 is adopted to show conventional pipeline processing necessary to execute a return instruction on the basis of an object program compiled in the conventional way. In the conventional, the pipeline (1) is used to execute [add.b #36, sp] and a stack area for which interrupt processing is secured at the EXE is opened based on the following formula (6):

sp=sp+(operand×4) (6).

In the pipeline (2), the [rt13] is executed, and then at the EXE in the pipeline (3), the stack area used for the evacuation of both the return address and the state flag is opened based on the execution of the following formula (7):

sp=sp+4 (7).

More practically, in the case of the conventional program, the return processing includes processing with which the stack area is opened in the two-stage manner based on the formulas (6) and (7). In contrast, the present embodiment allows the processing on the formulas (61 and (7) can be executed in block with the formula (5), whereby time necessary for the return processing is shortened.

As stated above, in the present embodiment, the return instruction [rtm3] handled by the CPU8 enables the open size of the stack area to be specified by the operand of the return instruction. This means that the conventional two-stage return processing (that is, the first instruction to open a stack area used when interrupt processing is executed and the second instruction to return from the interrupt processing) can be performed with only one-stage return processing. In the conventional, this two-stage return processing was necessary, because it was required to separately open the stack area (secured by the CPU hardware configuration) in which a return address was temporarily stored for the return from interrupt processing. Unlike this conventional configuration, the one-stage return processing in the first embodiment makes it possible to shorten a duration from an interrupt to a return from the interrupt.

Still, when it is necessary to open the stack area in the return from the interrupt processing, the compiler 2 produces the object code file 4 so as to specify the open size of the operand of the return instruction [rtm3], whereby the program 100 executable by the CPU 8 can be produced. Besides, the object code file 4 can be made smaller in the size.

Moreover, the microcomputer 6 is equipped with the ROM 7 in which the object program produced by the compiler 2 is stored, which allows the CPU 8 to execute the object program to make the processing faster.

(Second Embodiment)

Referring to FIGS. 11 to 14, a second embodiment of the present invention will now be described, in which the same components to those in the first embodiment are given the same reference numerals, thus those components being omitted from being described and only different components from them being described (this manner of description will also be adopted by a third embodiment and subsequent embodiments, which will be described later).

FIG. 11 is a flowchart explaining, as to only part relating to the second embodiment, the processing performed by the compiler 2.

In the second embodiment, a user is able to describe a program for interrupt processing in the source code file 3 such that the compiler 2 determines whether the interrupt processing is an exceptional interrupt or an ordinary interrupt. The exceptional interrupt is an interrupt that occurs within the CPU 8 in cases where some error is caused, while the ordinary interrupt is an interrupt other than the exceptional interrupt and is lower in the priority. Even when the ordinary interrupt may occur during the processing of the exceptional interrupt, the configuration is made so that the CPU 8 is masked.

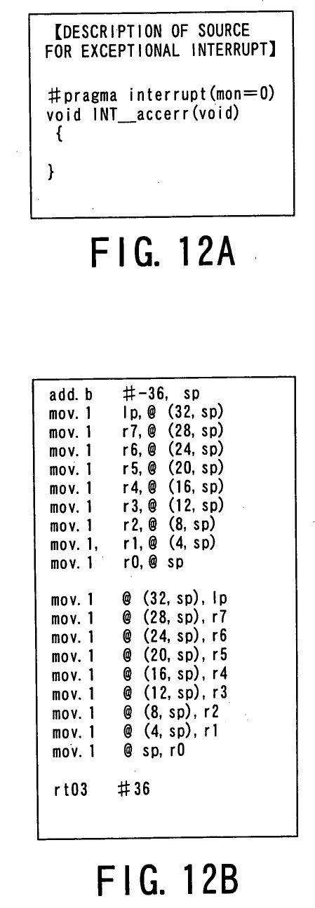

FIG. 12A exemplifies an exceptional interrupt, which is processed when an error about an address access is issued. At the beginning of a program shown in FIG. 12A, there is a description of

#pragma interrupt (mon=0).

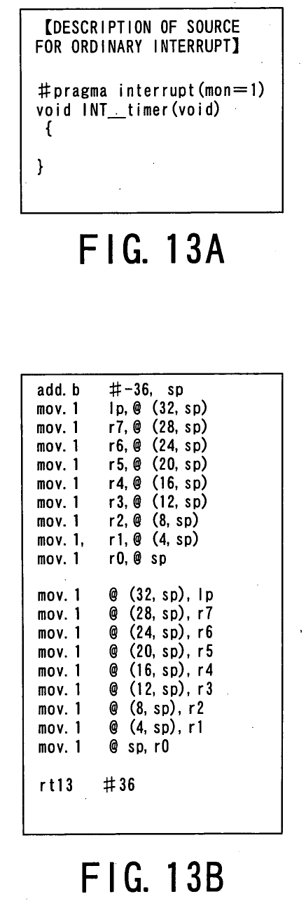

Of this description, the last term “(mon=0)” shows that this is the processing for an exceptional interrupt. Further, FIG. 13A shows an ordinary interrupt performed as processing for a timer interrupt, at the beginning of which a statement of

#pragma interrupt (mon=1)

is written. The last term “(mon=1)” shows that this is the processing for an ordinary interrupt.

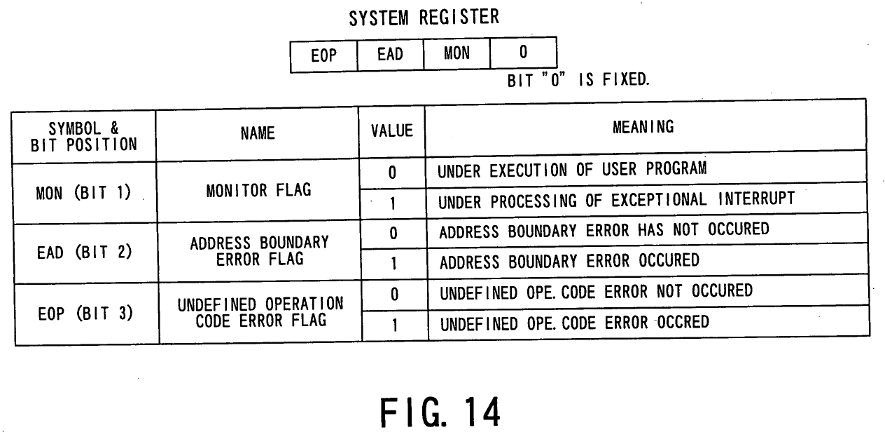

FIG. 14 shows the bit configuration of a system register 26 functioning as an internal register within the CPU 8. A bit “1” of the system register 26 provides a flag MON during a monitoring operation. This flag MON is reset to “0” if the CPU 8 is under execution of a user program, but set to “1” by the hardware of the CPU 8 if the CPU 8 is under execution of processing for an exceptional interrupt.

The CPU 8 is configured to prohibit other exceptional interrupts and ordinary interrupts from being received, if the flag MON has already been set to “1.” For the conventional user program, it was required to describe the flag MON so that the flag MON be reset to “0” after completing the execution of processing for the exceptional interrupt.

The second embodiment improves this point of view. In other words, unlike the conventional, in place of processing to reset the flag MON to “0,” setting is made such that “(mon=0)” is described at the beginning of processing for an exceptional interrupt. The description of (mon=0, 1) will cause the compiler 2 to determine interrupt processing is an exceptional interrupt or an ordinary interrupt.

In the processing shown in FIG. 11, first of all, the compiler 2 determines whether the description at the beginning of an interrupt processing program in the source code program 3 is “mon=0)” or “mon=1” (step S4). If there is the description of “(mon=0),” the processing should be executed for an exceptional interrupt (step S5), thereby producing a return instruction [rt03] according to the exceptional interrupt (step S6).

In contrast, when the determination at step S4 shows that there is the description of “(mon=1), the processing should be performed concerning an ordinary interrupt (step S7), thus producing a return instruction [rt13] according to the ordinary interrupt (step S8).

As a result, after the compiling operation, the object code file 4 is produced as shown in FIG. 12B or FIG. 13B, respectively. If the return instruction is [rt03], the CPU 8 then makes the hardware perform the processing to reset the flag MON to “0.” Meanwhile if the return instruction is [rt13], the similar return processing to that in the first embodiment is performed.

As stated above, in the second embodiment, the return instructions to return from the exceptional interrupt processing and the ordinary interrupt processing, both of which are handled by the CPU 8, are assigned to mutually different descriptions. When the return instruction is exceptional interrupt processing, the hardware is made to operate to reset the flag MON of the system register 26 to “0.” It is therefore unnecessary for a user to describe the processing for resetting the flag MON to “0” in the source code file 3, so that a burden on the user's program can be reduced.

In addition, the compiler 2 determines the description of (mon=0, 1) in the source code file 3 to detect that an interrupt to be processed is an exceptional interrupt or an ordinary interrupt. The determined results are used to produce return instructions from the processing for the respective interrupts into different object codes [rt03] and [rt13], respectively. Hence an object program can be produced, in which the CPU 8 is able to execute the different return instructions in a distinguishable manner. This will enable a user to write more simply a program involving interrupt processing.

As to the second embodiment, there is provided a modification, in which the CPU 8 executes, as the ordinary interrupt processing, inherent processing different from the exceptional interrupt processing on the basis of differences in the return instructions.

(Third Embodiment)

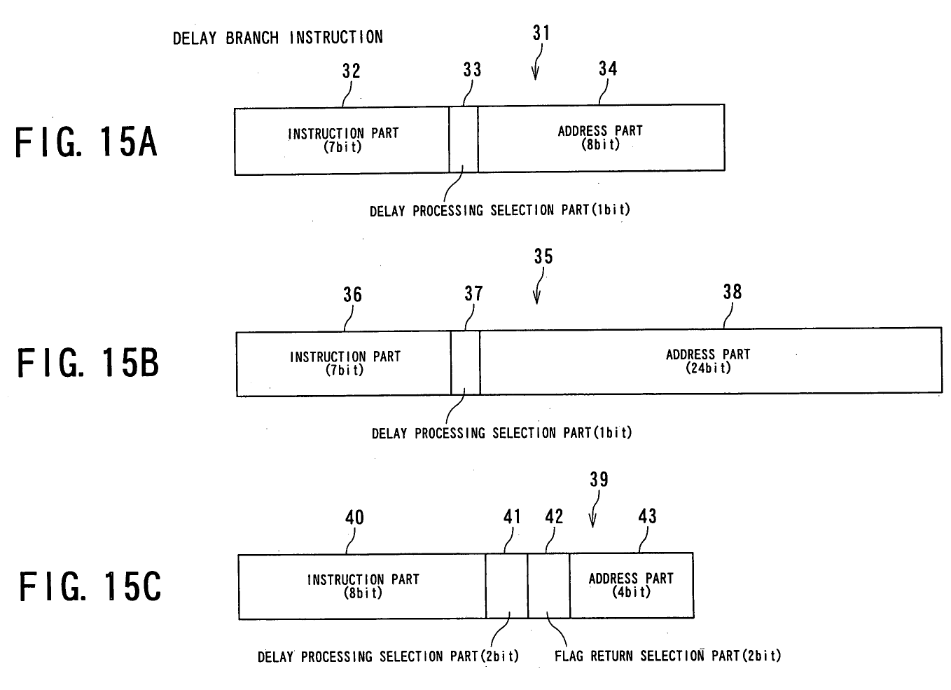

Referring to FIGS. 15 to 18, a third embodiment will now be described.

FIGS. 15A to 15C show the bit configurations of delay branch instructions produced by the compiler 2 according to the third embodiment. The delay branch instructions from the CPU 8 are categorized into three types shown therein, respectively.

FIG. 15A shows a one-word (16 bits) delay branch instruction 31 consisting of a 7-bit instruction part 32, 1-bit delay processing selection part 33, and 8-bit address part 34. FIG. 15B shows a two-word delay branch instruction 32 consisting of a 7-bit instruction part 36, 1-bit delay processing selection part 37, and 24-bit address part 34. FIG. 15C shows a one-word delay branch instruction 39 consisting of an 8-bit instruction part 40, 2-bit delay processing selection part 41, 2-bit flag return selection part 42, and 4-bit address part 43.

As can be understood from those bit configurations, the third embodiment features that those delay branch instructions 31, 35 and 39 are given the delay processing selection parts 33, 37 and 41, respectively. The CPU 8 is configured to control the flows of delay branches in response to bit states carried out by the delay processing selection part.

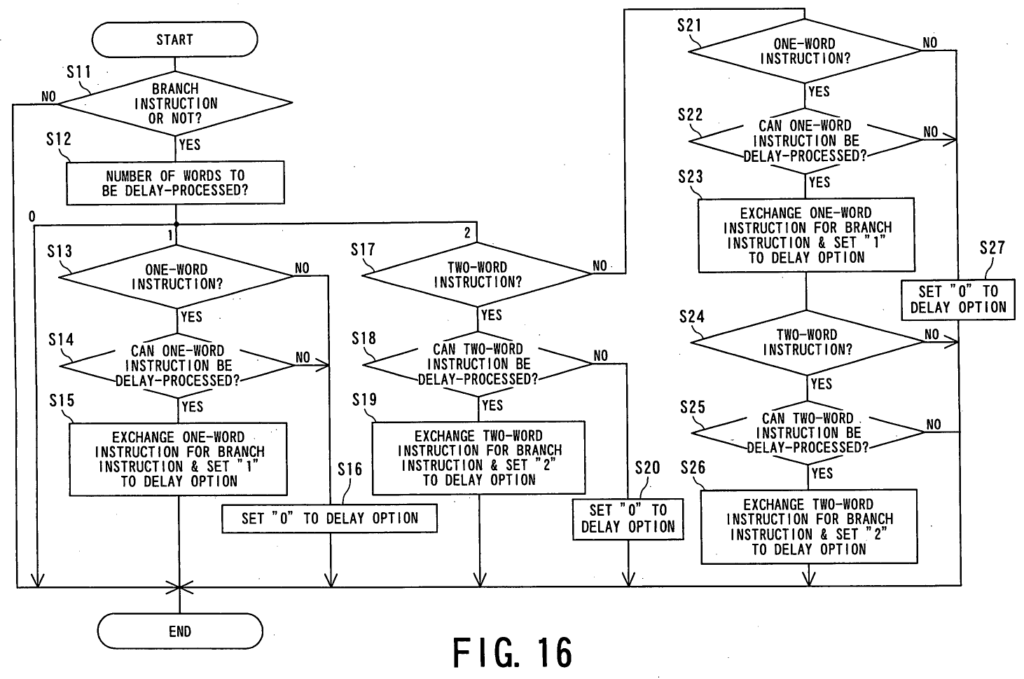

The compile processing for delay instructions in the source code file 3, which is performed by the compiler 2, is shown by a flowchart in FIG. 16. Only part concerning with the third embodiment is shown in FIG. 16.

The compiler 2 first determines if an instruction to be produced as an object is a branch instruction or not (step S11), and the processing is ended when there is no branch instruction (NO at step S1). In contrast, if there is a branch instruction (YES at step S11), the compiler 2 checks the number of words which can be subjected to delay processing of the branch instruction (step S12). When the number of words is “0,” the processing is terminated.

When the number of words is “1,” the compiler 2 then determines whether or not an instruction immediately before the branch instruction is a one-word instruction (step S13). If this determination shows a one-word instruction (YES at step S13), the compiler 2 then determines if the immediacy-before one-word instruction is possible to be delay-processed in the flow of a program (step S14). If the determination is YES, that is, it is possible to apply the delay processing to the one-word instruction, the immediately-before one-word instruction is exchanged for the branch instruction and a value “1” is set to either the delay processing selection part 33 or 37 to form a delay option (delay branch option) for the branch instruction (step S15).

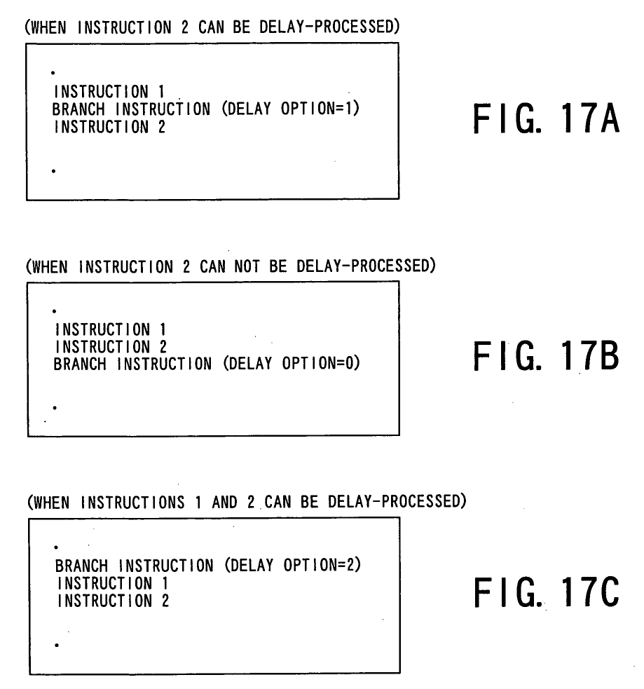

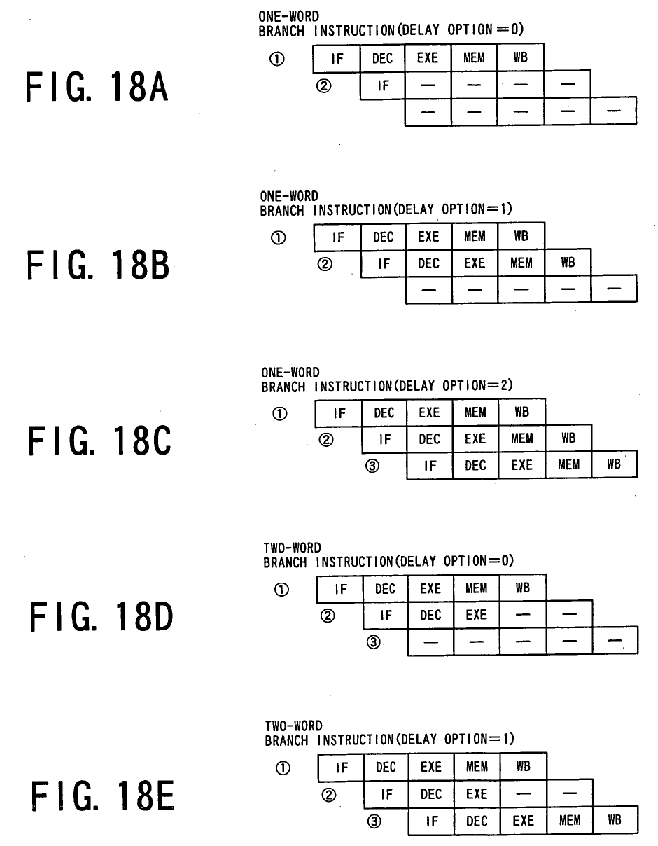

Hence, in cases where, for instance, the delay branch instruction 31 of which delay option is set to “1” is subjected to decoding executed by the CPU 8, the CPU8 is able to recognize that a one-word branch instruction which can be delay-processed is arranged next to the delay option. In this exemplified case, instructions are arranged in the object code file 4 as shown in FIG. 17A.

On the other hand, when the immediately-before instruction is not a one-word instruction or cannot be delay-processed, the determination at step S13 or S14, which is carried out by the compiler 2, becomes “NO.” Responsively to this, a value of “0” is set to the delay processing selection part 33 or others to form the delay option for the branch instruction (step S16). Hence, as long as the CPU 8 detects the delay option set to “0” in decoding a delay branch instruction, the CPU 8 knows the fact that an instruction which can be delay-processed is not arranged next to the delay branch instruction. In such a case, instructions are arranged in the object code file 4 as shown in FIG. 17B. Furthermore, the processing carried out in this case has no “nop” instruction at the position next to the branch instruction, which is remarkably distinguished from the conventional technique.

Back to step S12, when it is determined thereat that the number of words which can be delay-processed is “2,” the compiler 2 then determines whether or not an instruction arranged immediacy before the branch instruction is a two-word instruction (step S17). If YES at step S17 (i.e., the two-word instruction), the processing is shifted to step S18, where whether or not the two-word delay branch instruction can be delay-processed in the flow of a program is determined, like the case described at step S14. In the case that the delay processing is possible (YES at step S17), both the immediately-before instruction and the branch instruction are exchanged with each other and a delay option for the branch instruction is formed by assigning a value of “2” to the delay processing selection part 41 (step S19).

Hence, in cases where the delay branch instruction 39 of which delay option is set to “2” is subjected to decoding executed by the CPU 8, the CPU8 is able to recognize that a two-word branch instruction which can be delay-processed is arranged next to the delay option. In this exemplified case, instructions are arranged in the object code file 4 as shown in FIG. 17C.

However, when the determination at step S18 is NO, that is, compiler 2 determines that the immediately-before instruction is impossible to be delay-processed, the delay option for the branch instruction is formed by setting a value of “0” to the delay processing selection part 41 (step S20).

In the case that the immediately-before instruction is not the two-word instruction so that the compiler 2 issues the determination of “NO” at step S17, the processing is shifted to step S21. The processing at steps S21 to S23 and S27 is basically the similar to that at steps S13 to S16 except that the delay option “1” or “0” is set to the delay processing selection part 41.

After the processing at step S23, the compiler 2 shifts its processing to determinations at step S24 and S25, of which processing is similar to that at steps S21 and S22. When both determinations at steps S24 and S25 show “YES,” the processing similar to step S19 is performed at step S26. In contrast, when either determination at step S24 or S25 becomes “NO,” the processing comes to an end.

FIGS. 18A to 18E show states in which the CPU 8 applies pipeline processing to each of the branch instructions 31, 35 and 39, to which the delay options “0” to “2” are assigned respectively. FIG. 18A exemplifies a state in which the delay option=0 is set to either the one-word branch instruction 31 of 39. In this case, a pipeline (2) stops at IF, because a delay slot is unused. FIG. 18B shows the one-word branch instruction 31 or 39 to which the delay option=1 is set. The delay slot is used, so that the pipeline (2) is able to execute a one-word instruction placed next to the branch instruction 31 or 39.

Furthermore, FIG. 18C shows a state in which the delay option 2 is assigned to a one-word branch instruction 39. Because the delay slot is used, pipelines (2) and (3) are able to execute a two-word instruction coming next to the branch instruction 39 or two one-word instructions. FIG. 18D shows a state in which the delay option=0 is assigned to a two-word branch instruction 35. Because the delay slot is used, a pipeline (3) stops. Likewise, FIG. 18E shows a state in which the delay option=1 is assigned to a two-word branch instruction 35. This configuration adopts a delay slot, with the result that a pipeline (3) is able to execute a one-word instruction placed next to the branch instruction 35.

Accordingly, in the case of the third embodiment, the CPU 8 decides whether or not a program should be branched depending on the set values of the delay options in the branch instructions 31, 35 and 39. Hence the CPU 8 is allowed to determine that the instruction 31 or others should not be subjected to delay branch, when the branch instruction 31 or others is decoded. In such a case, there is no necessity for placing the “nop” instruction next to the branch instruction, thus reducing the size of object codes.

In addition, the compiler 2 is in charge of determining whether or not a specific instruction described before a branch instruction can be executed by a delay slot of the branch instruction, setting a delay branch option to the specific instruction depending on the determined results, and, if the specific instruction is executable, placing the specific executable instruction next to the branch instruction. The CPU8 is able to produce an object program in which the delay branch processing can be executed like the above.

(Fourth Embodiment)

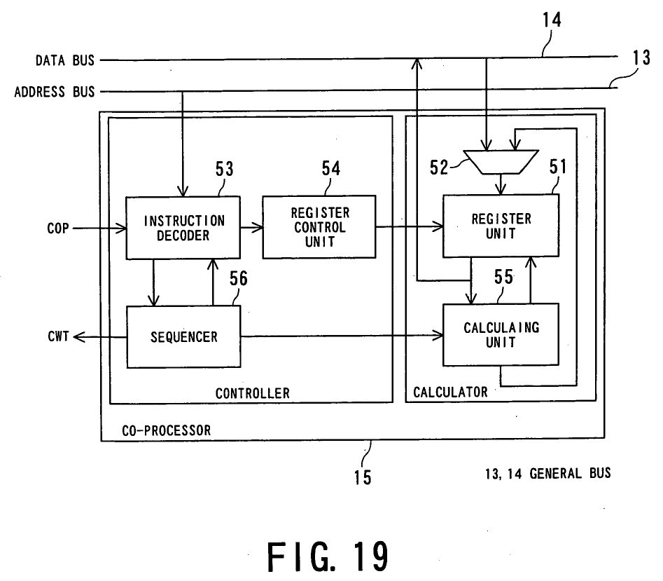

Referring to FIGS. 19 to 25, a fourth embodiment of the present invention will now be described.

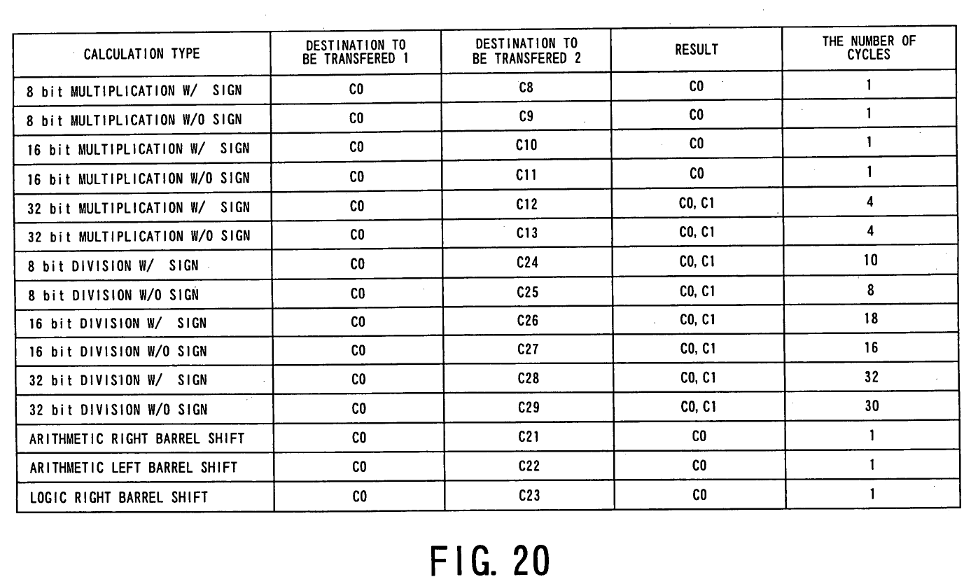

FIG. 19 shows a functional block diagram of the internal configuration of the co-processor 15. This co-processor 15 is provided with a register unit 51 taking in data appearing on the second data bus (general bus) via a multiplexer 52 as the need arises. The register unit 51 is composed of an aggregation of a plurality of data registers C0 to C29 shown in FIG. 20. These data registers C0 to C29 are subjected to various types of combinations of registers, which decide the types of computation to be executed.

The co-processor 15 is also provided with an instruction decoder 53 that is responsible for decoding an address outputted to the second address bus (general bus) 13 by the CPU 8, the address specifying an internal register of the co-processor 15. This allows the decoder 53 to decode a calculating instruction specified by the CPU 8. The co-processor 15 is also provided with a register control unit 54, a calculating unit 55, and a sequencer 56. Depending on the decoded result at the instruction decoder 53, a control instruction is outputted from the instruction decoder 53 to the register control unit 54 to control the register unit 51. Another control instruction is also supplied from the instruction decoder 53 to the sequencer 56 that is in charge of controlling the calculating unit 55.

The calculating unit 55 is configured to apply calculation to data to be given via the register unit 51. The calculated result is fed back to the register unit 51 by way of the multiplexer 52. Date to be outputted from the register unit 51 is supplied to the second data bus 14 as well.

The instruction decoder 53 is made to respond to only a dedicated instruction signal COP given by the CPU 8, and to decode data when activated by the signal COP. Further, the sequencer 56 is configured to provide the CPU 8 with a wait signal CWT, in cases where the co-processor 15 is accessed by the CPU 8 with the calculating unit 55 in calculating operation.

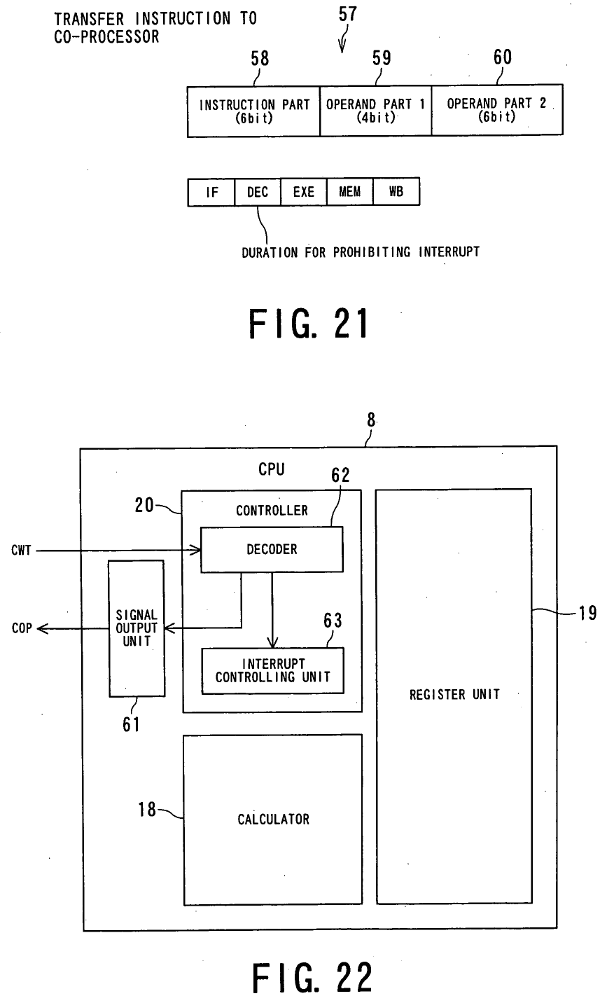

FIG. 21 shows the bit configuration of a transfer instruction 57 to be given from the CPU 8 to the co-processor 15. This transfer instruction 57 is made up of a 6-bit instruction part 58, a 4-bit first operand part 59, and a 6-bit second operand part 60. When decoding this transfer instruction 57 (that is, this transfer instruction is decoded at the stage DEC on the pipeline), the CPU 8 operates to prohibit the reception of an interrupt.

FIG. 22 outlines the internal configuration of the CPU 8, in which there are provided with a controller 20, calculator 18, register unit 19, and signal output unit 61. Of these units, the controller 20 is equipped with a decoder 62 and an interrupt controlling unit 63. The decoder 62 is configured to decode an instruction, and to control both the signal output part 61 and the interrupt controlling unit 63 in response to the decoded result. When receiving the foregoing wait signal CWT from the co-processor 15, the decoder 62 operates to temporarily stop the pipeline processing. The signal output unit 61 responds to the temporary stop of the pipeline processing by providing the co-processor 15 with the foregoing dedicated instruction signal COP.

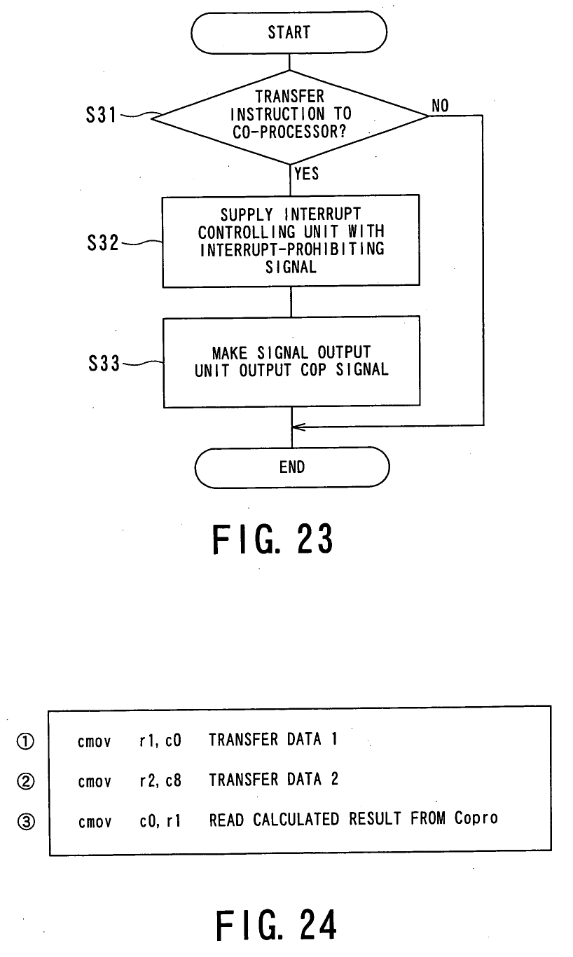

In connection with FIGS. 23 to 25, the operations of the fourth embodiment will now be described.

The decoding processing performed by the decoder 62 of the controller 20 is illustrated in FIG. 23, as a flowchart showing only part in relation to the fourth embodiment.

The decoder 62 determines whether or not a decoded result indicates a transfer instruction to the co-processor (step S31). If being YES at step S31 (i.e., the transfer instruction is issued), the decoder 62 supplies the interrupt controlling unit 63 with an interrupt-prohibiting signal (step S32). Further, when the processing on the pipeline is shifted to the stage MEM, the signal output unit 61 is made to output the dedicated instruction signal COP to the co-processor 14 (step S33).

Exemplified in FIG. 24 are object codes produced by the compiler 2 on condition that the CPU 8 is placed to be in cooperation with the co-processor 15. The object codes include [cmov], which is a dedicated instruction used to make the co-processor 15 perform its calculation. Specifically, data in a register r1 of the CPU 8 is transferred to a register C0 of the co-processor 15, and data in a register r2 is transferred to a register C8 as well. The calculation in this example is 8-bit multiplication with signs. The calculated result is stored in the register C0 (refer to FIG. 20). Hence data in the register C0 is read out and sent to the register r1.

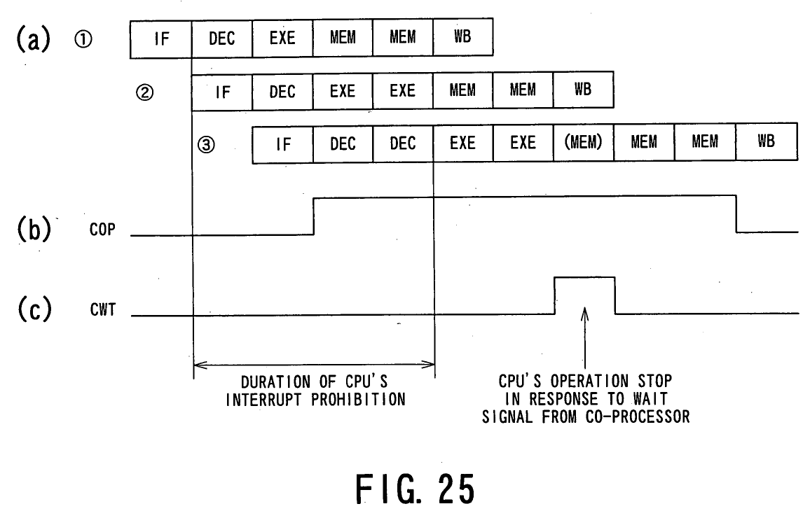

For executing the object codes shown in FIG. 24, the pipeline processing and the output states of respective signals can be illustrated as shown in FIG. 25. Pipelines (1) to (3) illustrated in FIG. 25(a) correspond to the respective codes in FIG. 24. When the stage is shifted to MEM on the pipeline (1), the signal output unit 61 outputs the dedicated instruction signal COP to the co-processor 15. Then, in the CPU 8, the stage DEC becomes continuous through the pipelines (1) to (3), whereby the decoder 62 prohibits an interrupt from being received.

On completion of the duration during which the interrupt is prohibited, the pipeline (2) is allowed to perform an external access MEM, so that, after the transfer to the co-processor 15, the co-processor 15 starts the multiplication. In the CPU 8, next to the stage EXE on the pipeline (3), the stage is shifted to MEM to read out data at the register C0 and send it to the register r1, while in the co-processor 15, the sequencer 56 recognizes such an access via the instruction decoder 53.

At this timing of the recognition, the calculation of the co-processor 15 is yet to be completed, the sequencer 56 makes the wait signal CWT active, which is to be sent to the CPU8. Responsively to this, the stage is stopped at MEM on the pipeline (3), providing a temporary stop state of the CPU 8. On completing the calculation performed by the co-processor 15, the wait signal CWT is made to be inactive, so that the stage MEM on the pipeline (3) is executed to read out its calculated result. Incidentally, though an interrupt to the CPU 8 can be made to be received from the stage EXE on the pipeline (3), processing for the interrupt will now be executed until the processing on the pipeline (3) is completed.

As stated above, the configuration according to the present fourth embodiment is provided with the co-processor 15 only to which the right to issue the decodable dedicated instruction [cmov] is given. During a period of time in which the dedicated instruction is decoded, any interrupt is prohibited from being received. Hence, even when other devices such as peripheral circuit are coupled with the CPU 8, the co-processor 15 is prevented from being accessed by the other devices.

In addition, based on a decoded result at the decoder 62, the interrupt controlling unit 63 of the CPU 8 automatically prohibits interrupts from being received. Thus user's concern with the interrupt control is not necessary, whereby there is no necessity for allowing the co-processor 15 to output an interrupt prohibiting signal. This leads to a more simplified configuration for prohibiting interrupts from being received, in cases where the CPU 8 has access to the co-processor 15.

When producing object codes to be executed by the co-processor 15, the compiler 2 arranges the object codes so that access instructions to the co-processor 15 are continuous and performs its processing so as not to perform interrupt processing until the CPU 8 obtains a result calculated by the co-processor 15. Hence the CPU 8 is able to, together with the co-processor, calculate processing in a continuous manner.

Furthermore, the microcomputer 6 is configured by employing both the CPU 8 and the co-processor 15 connected by the general buses 13 and 14. In this configuration, the CPU 8 supplies the co-processor 15 with the dedicated instruction signal COP in response to decoding the dedicated instruction, while the co-processor 15 decodes the calculating instruction given by the CPU 8 when receiving the dedicated instruction signal. It is therefore possible to surely prevent the co-processor 15 from being accessed improperly by other devices. When accessing the co-processor 15, the computer 6 is able to have a configuration equipped with the CPU 8 capable of easily prohibiting an interrupt from being received.

Still, in response to an access by the CPU 8 during the execution of calculation, the co-processor 15 outputs the wait signal CWT to temporarily stop the processing done by the CPU 8. Responsively, the CPU 8 refrains from the pipeline processing during a period of time in which the wait signal CWT is outputted. Accordingly, interrupts from the CPU 8 are kept on prohibiting from being received until the co-processor 15 completes its calculation.

There is provided a modification concerning the fourth embodiment, in which a period of time for prohibiting interrupts from being received, which is executed by the CPU, may be arranged at the stage EXE of pipeline processing, if the configuration of the CPU demands.

(Fifth Embodiment)

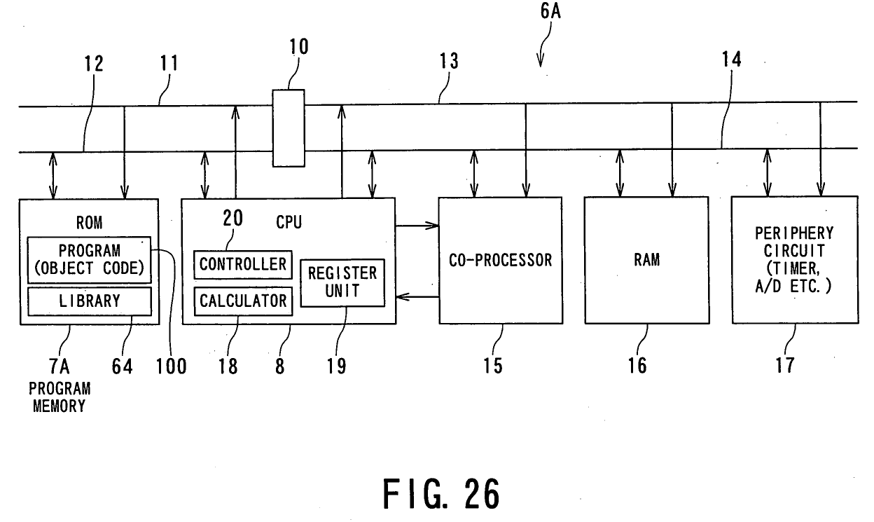

Referring to FIGS. 26 to 28, a fifth embodiment of the present invention will now be described.

The fifth embodiment features that, when performing compile processing, the compiler 2 is able to select either one of two techniques depending on user's set information: one technique is to allow the co-processor 15 to calculate the compile processing and the other is, as shown in FIG. 26, to use a library 64 prepared in the ROM 7A.

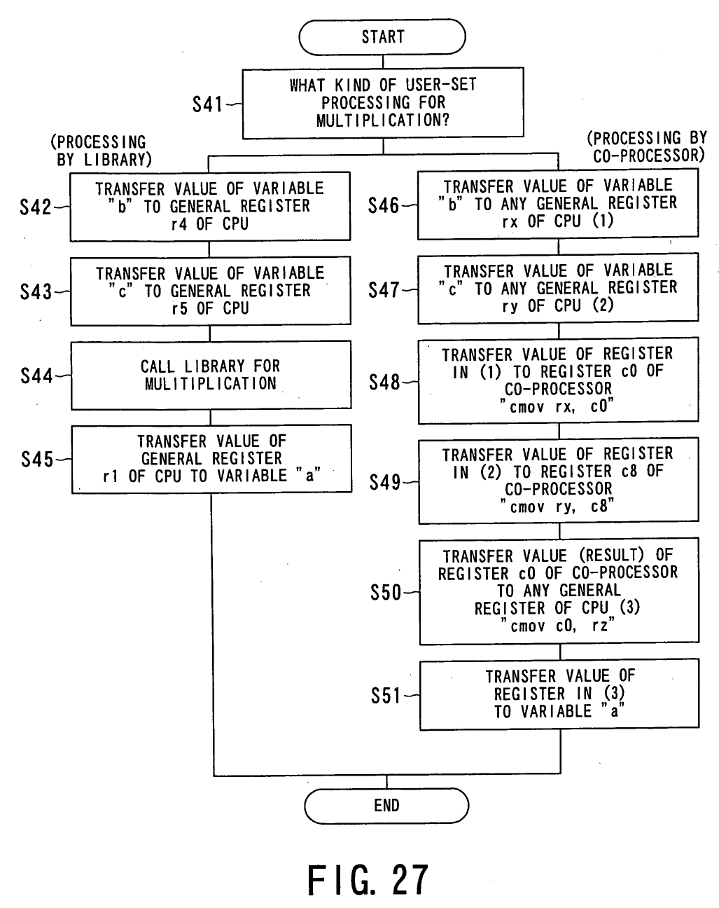

FIG. 27 shows a partial flowchart concerning with only the gist provided by the fifth embodiment and exemplifies multiplication (for instance, a=b·c).

The compiler 2 determines what kind of processing is specified by a user in order to perform the multiplication (step S41). In the present embodiment, as the way of processing the multiplication, two types are prepared; one is to use a library 64 and the other is to use the co-processor. When the user specifies to use the library 64, the compiler 2 produces a code to transfer the value of a variable “b” to a general register r4 of the CPU 8 (step S42), and then another code to transfer the value of a variable “c” to a general register r5 (step S43). Further, a code to call the library 64 is produced (step S44).

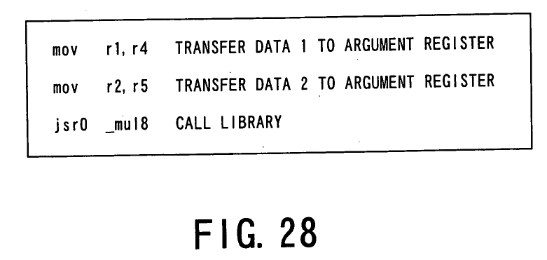

FIG. 28 illustrates object codes produced through the above procedures. After the CPU 8 calls the library 64, the library 64 is allowed to execute the multiplication (a=b·c), thus a product “a” being set to a general register r1. Hence, at the next step S45, produced is a code to transfer the value at the general register r1 to the variable “a.”

On the other hand, the user specifies the use of the co-processor 15 in performing the multiplication, the compile processing to produce codes, which is shown in FIG. 24 according to the foregoing fourth embodiment, is carried out as steps S46 to S51 in FIG. 27. Specifically, a code is produced to transfer the value of the variable “b” to any general register rx of the CPU 8 (step S46), and a code is produced to transfer the value of the variable “c” to any general register ry (step S47). And a code to transfer the value at the general register rx to a register c0 of the co-processor 15 is produced (step 48), before a code for a transfer of the value at the general register ry to a register c8 is produced (step S49). Further, a code is produced to transfer the value at the register c0 of the co-processor 15 to any general register rz (step S50). Finally, a code to make the value of the general register rz transfer to the variable “a” is produced (step S51).

As described above, the compiler 2 according to the fifth embodiment is selectable as to whether the calculation to produce the object codes entrusts either the co-processor 15 or the library 64 in response to user-specified information. This selection can be made in units of the source code file 3. Thus, for selecting how to compile the processing, it is possible for a user to select the co-processor 15 if a fast calculation is desired and to select the library 64 if a fast calculation is not required.

The present invention may be embodied in other specific forms without departing from the spirit or essential characteristics thereof. The present embodiments are therefore to be considered in all respects as illustrative and not restrictive, the scope of the present invention being indicated by the appended claims rather than by the foregoing description and all changes which come within the meaning and range of equivalency of the claims are therefore intended to be embraced therein.

The entire disclosure of Japanese Patent Application No. 2002-374527 filed on Dec. 25, 2002 including the specification, claims, drawings and summary is incorporated herein by reference in its entirety.

What is claimed is:

1 A RISC type of CPU executing an object program in which a stack area is used, comprising:
means configured to have a return instruction based on an operand at which an open size is specified; and
means configured to perform the return instruction when the stack area is required to be opened in returning processing executed by the CPU from interrupt processing to ordinary processing with no interrupt.

2. A RISC type of CPU executing an object program in which processing is returned from either exceptional interrupt processing or ordinary interrupt processing to ordinary processing with no interrupt, comprising:
means configured to have mutually different return instructions assigned to both the exceptional interrupt processing and the ordinary interrupt processing, respectively, either one of the exceptional interrupt processing and the ordinary interrupt processing being different from the other; and
means configured to perform each of the return instructions depending on which of the exceptional interrupt processing and the ordinary interrupt is required.

3. A compiler for compiling a source program into object codes, comprising:
means configured to determine whether or not a stack area in the source program is required to be opened when processing in the source program is returned from interrupt processing to ordinary processing with no interrupt; and
means configured to produce the object codes in which an operand for a return instruction is included and an open size for the stack area is specified at the operand.

4. A compiler for compiling a source program into an object file, comprising;
means configured to receive the source program in which at least processing for an exceptional interrupt and an ordinary interrupt is described so that both the processing for the exceptional interrupt and the processing for the ordinary interrupt are distinguishable from each other; and
means configured to produce, as different object codes to be included in the object file, return instructions from the processing for the respective interrupts.

5. A RISC type of CPU executing an object program in which instructions are written, comprising,
means configured to read a branch instruction in the object program, the branch instruction having a delay branch option for determining whether or not an instruction described next to the branch instruction is required to be executed; and
means configured to decide whether or not the object program is branched depending on the delay branch option.

6. A compiler for compiling a source program into object codes, comprising;
means configured to determine whether or not an instruction described before a branch instruction having a delay slot in the source program is executable at the delay slot of the branch instruction;
means configured to set to the branch instruction a delay branch option indicative of “delay processing is required,” when the instruction described before the branch instruction is executable and to arrange the executable instruction next to the branch instruction; and
means configured to produce the object codes in which a further delay branch option indicative of “delay processing is not required,” when the instruction described before the branch instruction is not executable is set to the branch instruction.

7. A RISC type of CPU executing an object program in which instructions are written, comprising,
means configured to have a dedicated instruction decodable by only a co-processor, the dedicated instruction being one of the instructions in the object program and being used to have access to the co-processor; and
means configured to prohibit an interrupt from being received during a period of time in which the dedicated instruction is decoded or executed.

8. A compiler for compiling a source program into object codes executed by a RISC type of CPU, instructions being written in the object codes, the CPU comprising means configured to output a dedicated instruction decodable by only a co-processor, the dedicated instruction being one of the instructions in the object codes and being used to have access to the co-processor; and means configured to prohibit an interrupt from being received during a period of time in which the dedicated instruction is decoded or executed, the compiler comprising;
means configured to determine information set by a user, the information indicative of which of the co-processor and a library is to perform calculation necessary for executing the object codes; and
means configured to selectively specify, every file of the source program, either one of the co-processor and the library to perform the calculation depending on the determined information.

9. The compiler according to claim 8, comprising means configured to compile the source program into the object codes executed by the co-processor, plural access instructions to the co-processor being arranged continuously, whereby the interrupt to the CPU is prohibited from being received during a period of time in which the CPU waits for receiving a calculated result from the co-processor.

10. A microcomputer comprising:
a RISC type of CPU executing an object program in which instructions are written, the CPU comprising means configured to output a dedicated instruction decodable by only a co-processor, the dedicated instruction being one of the instructions in the object program and being used to have access to the co-processor, and means configured to prohibit an interrupt from being received during a period of time in which the dedicated instruction is decoded or executed; and
a co-processor connected to the CPU via a bus.

11. The microcomputer according to claim 10, wherein the bus is a general bus;
the CPU comprises means configured to output a dedicated instruction signal to the co-processor when the CPU decodes the dedicated instruction; and
the co-processor comprises means configured to decode a calculating instruction given by the CPU in cases where the co-processor inputs the dedicated instruction signal.

12. The microcomputer according to claim 10, wherein
the co-processor comprises means configured to output a stop signal to temporarily stop processing performed by the CPU, when the co-processor receives an access from the CPU during the calculation performed by the co-processor; and
the CPU comprises means for configured to perform the processing as pipeline processing and mans for stopping the pipeline processing during a period of time in which the stop signal is outputted from the co-processor.

13. The microcomputer according to claim 11, wherein
the co-processor comprises means configured to output a stop signal to temporarily stop processing performed by the CPU, when the co-processor receives an access from the CPU during the calculation performed by the co-processor; and
the CPU comprises means for configured to perform the processing as pipeline processing and mans for stopping the pipeline processing during a period of time in which the stop signal is outputted from the co-processor.

14. The microcomputer according to claim 10, comprising a program memory in which the object program is memorized, the object program being complied by a compiler from a source program,
wherein the compiler comprises:
means configured to determine whether or not a stack area in the source program is required to be opened when processing in the source program is returned from interrupt processing to ordinary processing with no interrupt; and
means configured to produce the object codes in which an operand for a return instruction is included and an open size for the stack area is specified at the operand.

15. The microcomputer according to claim 10, comprising a program memory in which the object program is memorized, the object program being complied by a compiler from a source program,
wherein the compiler comprises:
means configured to receive the source program in which at least processing for an exceptional interrupt and an ordinary interrupt is described so that both the processing for the exceptional interrupt and the processing for the ordinary interrupt are distinguishable from each other; and
means configured to produce, as different object codes to be included in the object file, return instructions from the processing for the respective interrupts.

16. The microcomputer according to claim 10, comprising a program memory in which the object program is memorized, the object program being complied by a compiler from a source program,
wherein the compiler comprises:
means configured to determine whether or not an instruction described before a branch instruction having a delay slot in the source program is executable at the delay slot of the branch instruction;
means configured to set to the branch instruction a delay branch option indicative of “delay processing is required,” when the instruction described before the branch instruction is executable and to arrange the executable instruction next to the branch instruction; and
means configured to produce the object codes in which a further delay branch option indicative of “delay processing is not required,” when the instruction described before the branch instruction is not executable is set to the branch instruction.

17. The microcomputer according to claim 10, comprising a program memory in which the object program is memorized, the object program being complied by a compiler from a source program, instructions being written in the object program,
wherein the CPU comprises;
means configured to output a dedicated instruction decodable by only a co-processor, the dedicated instruction being one of the instructions in the object codes and being used to have access to the co-processor; and
means configured to prohibit an interrupt from being received during a period of time in which the dedicated instruction is decoded or executed,
wherein the compiler comprises;
means configured to determine information set by a user, the information indicative of which of the co-processor and a library is to perform calculation necessary for executing the object codes; and
means configured to selectively specify, every file of the source program, either one of the co-processor and the library to perform the calculation depending on the determined information.

18. The microcomputer according to claim 17, wherein the compiler comprises means configured to compile the source program into the object codes executed by the co-processor, plural access instructions to the co-processor being arranged continuously, whereby the interrupt to the CPU is prohibited from being received during a period of time in which the CPU waits for receiving a calculated result from the co-processor.

19. A co-processor connected to a RISC type of CPU to form a microcomputer, the CPU executing an object program in which instructions are written,
wherein the CPU comprises
means configured to output a dedicated instruction decodable by only a co-processor, the dedicated instruction being one of the instructions in the object program and being used to have access to the co-processor, and
means configured to prohibit an interrupt from being received during a period of time in which the dedicated instruction is decoded or executed.
